(19) United States
(12) Patent Application Publication
(10) Pub. No.: US 2009/0184825 A1
(43) Pub. Date: Jul. 23, 2009

(54) RFID Transponder Used for Instrument Identification in an Electromagnetic Tracking System

(75) Inventor: Peter Traneus Anderson, Andover, MA (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/018,632

(22) Filed: Jan. 23, 2008

(51) Int. Cl. G08B 13/14

(52) U.S. Cl. 340/572.1

(57) ABSTRACT

A system and method for instrument identification in an electromagnetic tracking system. The system and method comprising at least one electromagnetic transmitter and receiver assembly; at least one medical device or instrument removably coupled to the at least one electromagnetic transmitter or receiver assembly; and an RFID transponder attached to the medical device or instrument. The RFID transponder is programmed with data including a unique identifier for identifying the medical device or instrument it is attached to. The at least one electromagnetic receiver or transmitter assembly is configured to read data including the unique identifier from the RFID transponder for identifying the medical device or instrument removably coupled to the to the at least one electromagnetic transmitter or receiver assembly.

### BACKGROUND OF THE INVENTION

This disclosure relates generally to radio frequency identification (RFID) systems and methods, and more particularly to an RFID transponder used for instrument identification in an electromagnetic tracking system.

Electromagnetic tracking systems have been used in various industries and applications to provide position and orientation information of instruments. For example, electromagnetic tracking systems may be useful in aviation applications, motion sensing applications, retail applications, and medical applications. In medical applications, electromagnetic tracking systems track the precise location of surgical instruments in relation to multidimensional images of a patient's anatomy. Additionally, electromagnetic tracking systems use visualization tools to provide the surgeon with co-registered views of the surgical instruments with the patient's imaged anatomy.

Generally, an electromagnetic tracking system may include an electromagnetic transmitter with one or more transmitter coils, an electromagnetic receiver with one or more receiver coils, electronics to generate a current drive signal for the one or more transmitter coils and to measure the mutual inductances between transmitter and receiver coils, and a computer to calculate the position and orientation of the receiver coils with the respect to the transmitter coils, or vice versa.

The electromagnetic tracking system is capable of tracking many different types of devices or instruments during different procedures. Depending on the procedure, the at least one device may be a surgical instrument (e.g., an imaging catheter, a diagnostic catheter, a therapeutic catheter, a guidewire, a debrider, an aspirator, a handle, a guide, etc.), a surgical implant (e.g., an artificial disk, a bone screw, a shunt, a pedicle screw, a plate, an intramedullary rod, etc.), or some other device. Depending on the context of the usage of the electromagnetic tracking system, any number of suitable devices, implants or instruments may be used. When tracking an instrument, it is helpful to identify the type of instrument being tracked. Currently, the ability to identify the instrument is dependent on a plurality of magnets placed at certain predefined locations on the instrument or the instrument handle that are adjacent to Hall-effect sensors on the receiver or transmitter assembly circuitry when the instrument is attached to the receiver or transmitter assembly that is used to identify the type of the instrument being tracked. This provides the ability to identify instruments being tracked by detecting the unique bit pattern provided by the magnets, and associating the bit pattern with a specific instrument from a list of pre-configured instruments and bit patterns. However, the use of magnets and Hall-effect sensors provides a limited amount of data storage availability for instrument identification and other purposes.

Therefore, there is a need for a system and method of improved instrument identification that provides for more data storage availability and the ability to identify more instruments being tracked by an electromagnetic tracking system.

### BRIEF DESCRIPTION OF THE INVENTION

In an embodiment, a system for instrument identification in an electromagnetic tracking system comprising at least one electromagnetic transmitter assembly with one or more electromagnetic transmitter devices; at least one electromagnetic receiver assembly with one or more electromagnetic receiver devices, the at least one receiver assembly communicating with and receiving signals from the at least one transmitter assembly; at least one medical device or instrument removably coupled to the at least one electromagnetic transmitter assembly; and an RFID transponder attached to a medical device or instrument.

In an embodiment, a system for instrument identification in an electromagnetic tracking system comprising at least one electromagnetic transmitter assembly with one or more electromagnetic transmitter device; at least one electromagnetic receiver assembly with one or more electromagnetic receiver device, the at least one receiver assembly communicating with and receiving signals from the at least one transmitter assembly; at least one medical device or instrument removably coupled to the at least one electromagnetic receiver assembly; and an RFID transponder attached to a medical device or instrument.

In an embodiment, a method for instrument identification in an electromagnetic tracking system comprising attaching a RFID transponder to a medical device or instrument; removably coupling the medical device or instrument to an electromagnetic transmitter assembly; determining the identity of the medical device or instrument being tracked by reading data from the RFID transponder; and providing the identity of the medical device or instrument being tracked to a user.

In an embodiment, a method of a method for instrument identification in an electromagnetic tracking system comprising attaching a RFID transponder to a medical device or instrument; removably coupling the medical device or instrument to an electromagnetic receiver assembly; determining the identity of the medical device or instrument being tracked by reading data from the RFID transponder; and providing the identity of the medical device or instrument being tracked to a user.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram illustrating an exemplary embodiment of an electromagnetic tracking system;

FIG. 2 is a block diagram illustrating an exemplary embodiment of an electromagnetic tracking system;

FIG. 3 is a schematic diagram illustrating an exemplary embodiment of an electromagnetic receiver or transmitter coil array for an electromagnetic tracking system;

FIG. 4 is a schematic diagram illustrating an exemplary embodiment of an instrument with a RFID transponder attached thereto and an electromagnetic transmitter or receiver assembly coupled to the instrument;

FIG. 5 is a flow diagram illustrating an exemplary embodiment of a method 500 for instrument identification in an electromagnetic tracking system.

### DETAILED DESCRIPTION OF THE INVENTION

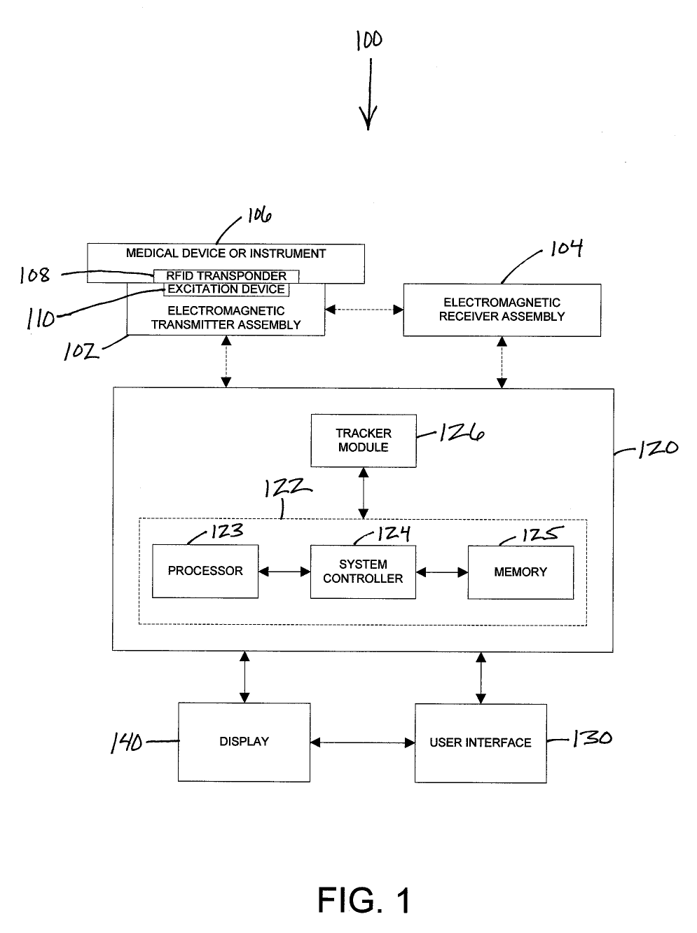

Referring now to the drawings, FIG. 1 is a block diagram illustrating an exemplary embodiment of an electromagnetic tracking system 100. The electromagnetic tracking system 100 comprises at least one electromagnetic transmitter assembly 102 with one or more electromagnetic transmitter devices, at least one electromagnetic receiver assembly 104 with one or more electromagnetic receiver devices, a tracker workstation 120 coupled to and receiving data from the at least one electromagnetic transmitter assembly 102 and the at least one electromagnetic receiver assembly 104, a user interface 130 coupled to the tracker workstation 120, and a display 140 coupled to the tracker workstation 120 and the user interface 130 for visualizing imaging and tracking data. The tracker workstation 120 includes a tracking system computer 122 and a tracker module 126. The tracking system computer 122 includes at least one processor 123, a system controller 124 and memory 125. At least one medical device or instrument 106 is removably coupled to the at least one electromagnetic transmitter assembly 102. The at least one medical device or instrument 106 includes an RFID transponder 108 attached thereto. The at least one electromagnetic transmitter assembly 102 includes an excitation device 110 to energize the RFID transponder 108. The at least one electromagnetic receiver assembly 104 is configured to act as an RFID reader communicating with the RFID transponder 108. The electromagnetic tracking system 100 is configured to measure six degrees of freedom of position and orientation data of the at least one medical device or instrument 106 removably coupled to the at least one electromagnetic transmitter assembly 102.

In an exemplary embodiment, the electromagnetic tracking system 100 provides a wireless data link between the at least one medical device or instrument 106 and the at least one electromagnetic receiver assembly 104 for medical device or instrument identification.

In an exemplary embodiment, the RFID transponder 108 may include an antenna for reception and transmission, a capacitor for energy storage, and an integrated circuit. The integrated circuit may include a radio transceiver, an analog to digital converter, a processor, and memory for information storage and retrieval. The integrated circuit requires a small amount of electrical power in order to function. The excitation device 110 produces a magnetic field that serves to power the RFID transponder 108. The antenna detects the magnetic field and converts it into electrical power for use by the integrated circuit. The RFID transponder 108 stores information and a unique identifier on the integrated circuit that is coupled to the antenna. The RFID transponder 108 communicates with the at least one electromagnetic receiver assembly 104 that is configured to act as an RFID reader. The at least one electromagnetic receiver assembly 104 (RFID reader) is configured to read the stored information and unique identifier from the RFID transponder 108. The stored information and unique identifier are then digitally transferred to the tracker workstation 120 and the tracking system computer 122 for processing.

In operation, the memory within the integrated circuit of the RFID transponder 108 is programmed with data including a unique identifier for the medical device or instrument 106 it is to be attached to. In order to read the data including the unique identifier from the RFID transponder 108, the RFID transponder 108 is activated by a magnetic field emitted by the excitation device 110 and received by the RFID transponder 108. The magnetic field induces a voltage in the RFID transponder circuitry to activate the RFID transponder 108. Following activation, the data including the unique identifier is transmitted to the at least one electromagnetic receiver assembly 104 (RFID reader) in the form of an electromagnetic signal. The electromagnetic signal is decoded and restructured by the at least one electromagnetic receiver assembly 104 (RFID reader) for transmission to the tracking system computer 122 for processing.

In an exemplary embodiment, the RFID transponder 108 may be a passive RFID transponder. A passive RFID transponder uses a magnetic field transmitted from an excitation device to power the RFID transponder.

In an exemplary embodiment, the RFID transponder 108 may be an active RFID transponder. An active RFID transponder includes a battery to power the RFID transponder.

In an exemplary embodiment, the RFID transponder 108 may be a RFID transponder manufactured by Texas Instruments Incorporated.

The one or more electromagnetic devices of the at least one electromagnetic transmitter and receiver assemblies 102, 104 may be built with various architectures, including various coil architectures and other electromagnetic sensor architectures. In the case of the various coil architectures, the one or more electromagnetic transmitter devices of the at least one electromagnetic transmitter assembly 102 may be single coils, a pair of single coils, industry-standard-coil-architecture (ISCA) type coils, a pair of ISCA type coils, multiple coils, or an array of coils. The one or more electromagnetic receiver devices of the at least one electromagnetic receiver assembly 104 may be single coils, a pair of single coils, ISCA type coils, a pair of ISCA type coils, multiple coils, or an array of coils.

ISCA type coils are defined as three approximately collocated, approximately orthogonal, and approximately dipole coils. Therefore, ISCA electromagnetic transmitter and receiver coils would include three approximately collocated, approximately orthogonal, and approximately dipole coils for the transmitter assembly and three approximately collocated, approximately orthogonal, and approximately dipole coils for the receiver assembly. In other words, an ISCA configuration for the electromagnetic transmitter and receiver assemblies would include a three-axis dipole coil transmitter and a three-axis dipole coil receiver. In the ISCA configuration, the transmitter coils and the receiver coils are configured such that the three coils (i.e., coil trios) exhibit the same effective area, are oriented orthogonally to one another, and are centered at the same point.

In an exemplary embodiment, the one or more coils of the at least one electromagnetic transmitter assembly 102 may be characterized as single dipole coils and emit magnetic fields when a current is passed through the coils. Those skilled in the art will appreciate that multiple electromagnetic field generating coils may be used in coordination to generate multiple magnetic fields. Similar to the at least one electromagnetic transmitter assembly 102, the one or more coils of the at least one electromagnetic receiver assembly 104 may be characterized as single dipole coils and detect the magnetic fields emitted by the at least one electromagnetic transmitter assembly 102. When a current is applied to the one or more coils of the at least one electromagnetic transmitter assembly 102, the magnetic fields generated by the coils may induce a voltage into each coil of the at least one electromagnetic receiver assembly 104. The induced voltage is indicative of the mutual inductance between the one or more coils of the at least one electromagnetic transmitter assembly 102. Thus, the induced voltage across each coil of the at least one electromagnetic receiver assembly 104 is detected and processed to determine the mutual inductance between each coil of the at least one electromagnetic transmitter assembly 102 and each coil of the at least one electromagnetic receiver assembly 104.

The magnetic field measurements may be used to calculate the position and orientation of the at least one electromagnetic transmitter assembly 102 with respect to the at least one electromagnetic receiver assembly 104, or vice versa according to any suitable method or system. The detected magnetic field measurements are digitized by electronics that may be included with the at least one electromagnetic receiver assembly 104 or the tracker module 126. The magnetic field measurements or digitized signals may be transmitted from the at least one electromagnetic receiver assembly 104 to the tracking system computer 122 using wired or wireless communication protocols and interfaces. The digitized signals received by the tracking system computer 122 represent magnetic field information detected by the at least one electromagnetic receiver assembly 104. The digitized signals are used to calculate position and orientation information of the at least one electromagnetic transmitter assembly 102 or the at least one electromagnetic receiver assembly 104.

The position and orientation information is used to register the location of the at least one electromagnetic receiver assembly 104 or the at least one electromagnetic transmitter assembly 102 to acquired imaging data from an imaging system. The position and orientation data is visualized on the display 140, showing in real-time the location of the at least one electromagnetic transmitter assembly 102 or the at least one electromagnetic receiver assembly 104 on pre-acquired or real-time images from the imaging system. The acquired imaging data may be from a computed tomography (CT) imaging system, a magnetic resonance (MR) imaging system, a positron emission tomography (PET) imaging system, an ultrasound imaging system, an X-ray imaging system, or any suitable combination thereof. All six degrees of freedom (three of position (x, y, z) and three of orientation (roll, pitch, yaw)) of the at least one electromagnetic receiver assembly 104 or the at least one electromagnetic transmitter assembly 102 may be determined and tracked.

In an exemplary embodiment, the one or more coils of the at least one electromagnetic transmitter and receiver assemblies 102, 104 may be precisely manufactured or precisely characterized during manufacture to obtain mathematical models of the one or more coils in the at least one electromagnetic transmitter and receiver assemblies 102, 104. From the magnetic field measurements and mathematical models of the one or more coils, the position and orientation of the at least one electromagnetic receiver assembly 104 with respect to the at least one electromagnetic transmitter assembly 102 may be determined. Alternatively, the position and orientation of the at least one electromagnetic transmitter assembly 102 with respect to the at least one electromagnetic receiver assembly 104 may be determined.

In an exemplary embodiment, the one or more electromagnetic devices of the at least one electromagnetic transmitter and receiver assemblies 102, 104 may be built with various electromagnetic sensor architectures, including, but not limited to flux gate magnetometer sensors, squid magnetometer sensors, Hall-effect sensors, anisotropic magneto-resistance (AMR) sensors, giant magneto-resistance (GMR) sensors, and extraordinary magneto-resistance (EMR) sensors.

In an exemplary embodiment, the at least one electromagnetic transmitter assembly 102 may be a wireless transmitter assembly or a wired transmitter assembly. In an exemplary embodiment, the at least one electromagnetic receiver assembly 104 may be a wireless receiver assembly or a wired receiver assembly.

In an exemplary embodiment, the tracker module 126 may include drive circuitry configured to provide a drive current to each electromagnetic device of the at least one electromagnetic transmitter assembly 102. By way of example, a drive current may be supplied by the drive circuitry to energize an electromagnetic device of the at least one electromagnetic transmitter assembly 102, and thereby generate an electromagnetic field that is detected by an electromagnetic device of the at least one electromagnetic receiver assembly 104. The drive current may be comprised of a periodic waveform with a given frequency (e.g., a sine wave, cosine wave or other periodic signal). The drive current supplied to an electromagnetic device will generate an electromagnetic field at the same frequency as the drive current. The electromagnetic field generated by an electromagnetic device of the at least one electromagnetic transmitter assembly 102 induces a voltage indicative of the mutual inductance in an electromagnetic device of the at least one electromagnetic receiver assembly 104. In an exemplary embodiment, the tracker module 126 may include receiver data acquisition circuitry for receiving voltage and mutual inductance data from the at least one electromagnetic receiver assembly 104.

In an exemplary embodiment, the tracking system computer 122 may include at least one processor 123, such as a digital signal processor, a CPU, or the like. The processor 123 may process measured voltage and mutual inductance data from the at least one electromagnetic receiver assembly 104 to track the position and orientation of the at least one electromagnetic transmitter assembly 102 or the at least one electromagnetic receiver assembly 104.

The at least one processor 123 may implement any suitable algorithm(s) to use the measured voltage signal indicative of the mutual inductance to calculate the position and orientation of the at least one electromagnetic receiver assembly 104 relative to the at least one electromagnetic transmitter assembly 102, or the at least one electromagnetic transmitter assembly 102 relative to the at least one electromagnetic receiver assembly 104. For example, the at least one processor 123 may use ratios of mutual inductance between each electromagnetic device of the at least one electromagnetic receiver assembly 104 and each electromagnetic device of the at least one electromagnetic transmitter assembly 102 to triangulate the relative positions of the electromagnetic devices. The at least one processor 123 may then use these relative positions to calculate the position and orientation of the at least one electromagnetic transmitter assembly 102 or the at least one electromagnetic receiver assembly 104.

In an exemplary embodiment, the tracking system computer 122 may include a system controller 124. The system controller 124 may control operations of the electromagnetic tracking system 100.

In an exemplary embodiment, the tracking system computer 122 may include memory 125, which may be any processor-readable media that is accessible by the components of the tracker workstation 120. In an exemplary embodiment, the memory 125 may be either volatile or non-volatile media. In an exemplary embodiment, the memory 125 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 130 may include devices to facilitate the exchange of data and workflow between the system and the user. In an exemplary embodiment, the user interface 130 may include a keyboard, a mouse, a joystick, buttons, a touch screen display, or other devices providing user-selectable options, for example. In an exemplary embodiment, the user interface 130 may also include a printer or other peripheral devices.

In an exemplary embodiment, the display 140 may be used for visualizing the position and orientation of a tracked object with respect to a processed image from an imaging system.

Notwithstanding the description of the exemplary embodiment of the electromagnetic tracking system 100 illustrated FIG. 1, alternative system architectures may be substituted without departing from the scope of this disclosure.

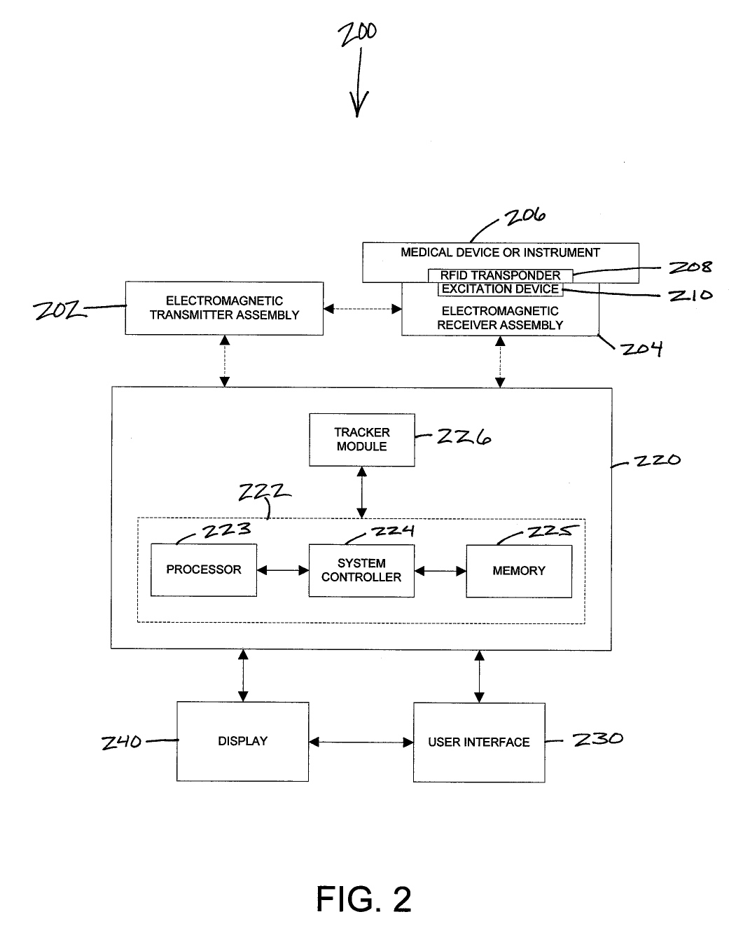

FIG. 2 is a block diagram illustrating an exemplary embodiment of an electromagnetic tracking system 200. The electromagnetic tracking system 200 comprises at least one electromagnetic transmitter assembly 202 with one or more electromagnetic transmitter devices, at least one electromagnetic receiver assembly 204 with one or more electromagnetic receiver devices, a tracker workstation 220 coupled to and receiving data from the at least one electromagnetic transmitter assembly 202 and the at least one electromagnetic receiver assembly 204, a user interface 230 coupled to the tracker workstation 220, and a display 240 coupled to the tracker workstation 220 and the user interface 230 for visualizing imaging and tracking data. The tracker workstation 220 includes a tracking system computer 222 and a tracker module 226. The tracking system computer 222 includes at least one processor 223, a system controller 224 and memory 225. At least one medical device or instrument 206 is removably coupled to the at least one electromagnetic receiver assembly 204. The at least one medical device or instrument 206 includes an RFID transponder 208 attached thereto. The at least one electromagnetic receiver assembly 204 includes an excitation device 210 to energize the RFID transponder 208. The at least one electromagnetic transmitter assembly 202 is configured to act as an RFID reader communicating with the RFID transponder 208. The electromagnetic tracking system 200 is configured to measure six degrees of freedom of position and orientation data of the at least one medical device or instrument 206 removably coupled to the at least one electromagnetic receiver assembly 204.

In an exemplary embodiment, the electromagnetic tracking system 200 provides a wireless data link between the at least one medical device or instrument 206 and the at least one electromagnetic transmitter assembly 202 for medical device or instrument identification.

In an exemplary embodiment, the RFID transponder 208 may include an antenna for reception and transmission, a capacitor for energy storage, and an integrated circuit. The integrated circuit may include a radio transceiver, an analog to digital converter, a processor, and memory for information storage and retrieval. The integrated circuit requires a small amount of electrical power in order to function. The excitation device 210 produces a magnetic field that serves to power the RFID transponder 208. The antenna detects the magnetic field and converts it into electrical power for use by the integrated circuit. The RFID transponder 208 stores information and a unique identifier on the integrated circuit that is coupled to the antenna. The RFID transponder 208 communicates with the at least one electromagnetic transmitter assembly 202 that is configured to act as an RFID reader. The at least one electromagnetic transmitter assembly 202 (RFID reader) is configured to read the stored information and unique identifier from the RFID transponder 208. The stored information and unique identifier are then digitally transferred to the tracker workstation 220 and the tracking system computer 222 for processing.

In operation, the memory within the integrated circuit of the RFID transponder 208 is programmed with data including a unique identifier for the medical device or instrument 206 it is to be attached to. In order to read the data including the unique identifier from the RFID transponder 208, the RFID transponder 208 is activated by a magnetic field emitted by the excitation device 210 and received by the RFID transponder 208. The magnetic field induces a voltage in the RFID transponder circuitry to activate the RFID transponder 208. Following activation, the data including the unique identifier is transmitted to the at least one electromagnetic transmitter assembly 202 (RFID reader) in the form of an electromagnetic signal. The electromagnetic signal is decoded and restructured by the at least one electromagnetic transmitter assembly 202 (RFID reader) for transmission to the tracking system computer 222 for processing.

In an exemplary embodiment, the RFID transponder 208 may be a passive RFID transponder. A passive RFID transponder uses a magnetic field transmitted from an excitation device to power the RFID transponder.

In an exemplary embodiment, the RFID transponder 208 may be an active RFID transponder. An active RFID transponder includes a battery to power the RFID transponder.

In an exemplary embodiment, the RFID transponder 208 may be a RFID transponder manufactured by Texas Instruments Incorporated.

The one or more electromagnetic devices of the at least one electromagnetic transmitter and receiver assemblies 202, 204 may be built with various architectures, including various coil architectures and other electromagnetic sensor architectures. In the case of the various coil architectures, the one or more electromagnetic transmitter devices of the at least one electromagnetic transmitter assembly 202 may be single coils, a pair of single coils, ISCA type coils, a pair of ISCA type coils, multiple coils, or an array of coils. The one or more electromagnetic receiver devices of the at least one electromagnetic receiver assembly 204 may be single coils, a pair of single coils, ISCA type coils, a pair of ISCA type coils, multiple coils, or an array of coils.

In an exemplary embodiment, the one or more coils of the at least one electromagnetic transmitter assembly 202 may be characterized as single dipole coils and emit magnetic fields when a current is passed through the coils. Those skilled in the art will appreciate that multiple electromagnetic field generating coils may be used in coordination to generate multiple magnetic fields. Similar to the at least one electromagnetic transmitter assembly 202, the one or more coils of the at least one electromagnetic receiver assembly 204 may be characterized as single dipole coils and detect the magnetic fields emitted by the at least one electromagnetic transmitter assembly 202. When a current is applied to the one or more coils of the at least one electromagnetic transmitter assembly 202, the magnetic fields generated by the coils may induce a voltage into each coil of the at least one electromagnetic receiver assembly 204. The induced voltage is indicative of the mutual inductance between the one or more coils of the at least one electromagnetic transmitter assembly 202. Thus, the induced voltage across each coil of the at least one electromagnetic receiver assembly 204 is detected and processed to determine the mutual inductance between each coil of the at least one electromagnetic transmitter assembly 202 and each coil of the at least one electromagnetic receiver assembly 204.

The magnetic field measurements may be used to calculate the position and orientation of the at least one electromagnetic transmitter assembly 202 with respect to the at least one electromagnetic receiver assembly 204, or vice versa according to any suitable method or system. The detected magnetic field measurements are digitized by electronics that may be included with the at least one electromagnetic receiver assembly 204 or the tracker module 226. The magnetic field measurements or digitized signals may be transmitted from the at least one electromagnetic receiver assembly 204 to the tracking system computer 222 using wired or wireless communication protocols and interfaces. The digitized signals received by the tracking system computer 222 represent magnetic field information detected by the at least one electromagnetic receiver assembly 204. The digitized signals are used to calculate position and orientation information of the at least one electromagnetic transmitter assembly 202 or the at least one electromagnetic receiver assembly 204.

The position and orientation information is used to register the location of the at least one electromagnetic receiver assembly 204 or the at least one electromagnetic transmitter assembly 202 to acquired imaging data from an imaging system. The position and orientation data is visualized on the display 240, showing in real-time the location of the at least one electromagnetic transmitter assembly 202 or the at least one electromagnetic receiver assembly 204 on pre-acquired or real-time images from the imaging system. The acquired imaging data may be from a CT imaging system, a MR imaging system, a PET imaging system, an ultrasound imaging system, an X-ray imaging system, or any suitable combination thereof. All six degrees of freedom (three of position (x, y, z) and three of orientation (roll, pitch, yaw)) of the at least one electromagnetic receiver assembly 204 or the at least one electromagnetic transmitter assembly 202 may be determined and tracked.

In an exemplary embodiment, the one or more coils of the at least one electromagnetic transmitter and receiver assemblies 202, 204 may be precisely manufactured or precisely characterized during manufacture to obtain mathematical models of the one or more coils in the at least one electromagnetic transmitter and receiver assemblies 202, 204. From the magnetic field measurements and mathematical models of the one or more coils, the position and orientation of the at least one electromagnetic receiver assembly 204 with respect to the at least one electromagnetic transmitter assembly 202 may be determined. Alternatively, the position and orientation of the at least one electromagnetic transmitter assembly 202 with respect to the at least one electromagnetic receiver assembly 204 may be determined.

In an exemplary embodiment, the one or more electromagnetic devices of the at least one electromagnetic transmitter and receiver assemblies 202, 204 may be built with various electromagnetic sensor architectures, including, but not limited to flux gate magnetometer sensors, squid magnetometer sensors, Hall-effect sensors, AMR sensors, GMR sensors, and EMR sensors.

In an exemplary embodiment, the at least one electromagnetic transmitter assembly 202 may be a wireless transmitter assembly or a wired transmitter assembly. In an exemplary embodiment, the at least one electromagnetic receiver assembly 204 may be a wireless receiver assembly or a wired receiver assembly.

In an exemplary embodiment, the tracker module 226 may include drive circuitry configured to provide a drive current to each electromagnetic device of the at least one electromagnetic transmitter assembly 202. By way of example, a drive current may be supplied by the drive circuitry to energize an electromagnetic device of the at least one electromagnetic transmitter assembly 202, and thereby generate an electromagnetic field that is detected by an electromagnetic device of the at least one electromagnetic receiver assembly 204. The drive current may be comprised of a periodic waveform with a given frequency (e.g., a sine wave, cosine wave or other periodic signal). The drive current supplied to an electromagnetic device will generate an electromagnetic field at the same frequency as the drive current. The electromagnetic field generated by an electromagnetic device of the at least one electromagnetic transmitter assembly 202 induces a voltage indicative of the mutual inductance in an electromagnetic device of the at least one electromagnetic receiver assembly 204. In an exemplary embodiment, the tracker module 226 may include receiver data acquisition circuitry for receiving voltage and mutual inductance data from the at least one electromagnetic receiver assembly 204.

In an exemplary embodiment, the tracking system computer 222 may include at least one processor 223, such as a digital signal processor, a CPU, or the like. The processor 223 may process measured voltage and mutual inductance data from the at least one electromagnetic receiver assembly 204 to track the position and orientation of the at least one electromagnetic transmitter assembly 202 or the at least one electromagnetic receiver assembly 204.

The at least one processor 223 may implement any suitable algorithm(s) to use the measured voltage signal indicative of the mutual inductance to calculate the position and orientation of the at least one electromagnetic receiver assembly 204 relative to the at least one electromagnetic transmitter assembly 202, or the at least one electromagnetic transmitter assembly 202 relative to the at least one electromagnetic receiver assembly 204. For example, the at least one processor 223 may use ratios of mutual inductance between each electromagnetic device of the at least one electromagnetic receiver assembly 204 and each electromagnetic device of the at least one electromagnetic transmitter assembly 202 to triangulate the relative positions of the electromagnetic devices. The at least one processor 223 may then use these relative positions to calculate the position and orientation of the at least one electromagnetic transmitter assembly 202 or the at least one electromagnetic receiver assembly 204.

In an exemplary embodiment, the tracking system computer 222 may include a system controller 224. The system controller 224 may control operations of the electromagnetic tracking system 200.

In an exemplary embodiment, the tracking system computer 222 may include memory 225, which may be any processor-readable media that is accessible by the components of the tracker workstation 220. In an exemplary embodiment, the memory 225 may be either volatile or non-volatile media. In an exemplary embodiment, the memory 225 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 230 may include devices to facilitate the exchange of data and workflow between the system and the user. In an exemplary embodiment, the user interface 230 may include a keyboard, a mouse, a joystick, buttons, a touch screen display, or other devices providing user-selectable options, for example. In an exemplary embodiment, the user interface 230 may also include a printer or other peripheral devices.

In an exemplary embodiment, the display 240 may be used for visualizing the position and orientation of a tracked object with respect to a processed image from an imaging system.

Notwithstanding the description of the exemplary embodiment of the electromagnetic tracking system 200 illustrated FIG. 2, alternative system architectures may be substituted without departing from the scope of this disclosure.

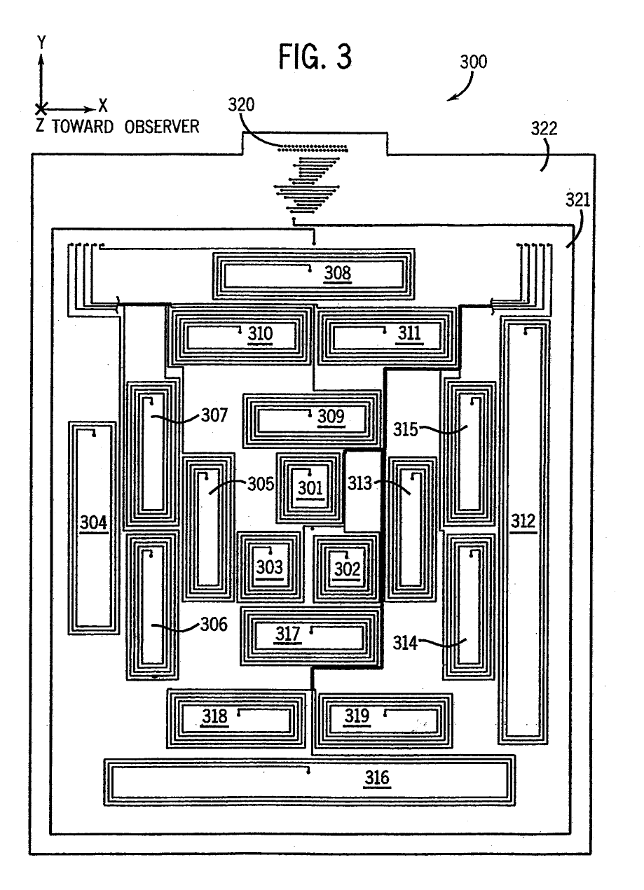

FIG. 3 is a schematic diagram illustrating an exemplary embodiment of an electromagnetic receiver or transmitter coil array 300 for an electromagnetic tracking system. It is well known by the electromagnetic principle of reciprocity, that a description of a coil's properties as a transmitter can also be used to understand the coil's properties as a receiver. Therefore, this example coil array 300 may be used as a transmitter or a receiver.

This example coil array 300 is formed by a plurality of flat coils of straight conductor traces forming square or rectangularly-shaped spiral coils on a printed circuit board (PCB) 322. The spiral coils are preferably copper traces with spaces in-between. The spiral coils may be single-sided or double-sided on the PCB 322. The PCB 322 may be a two-sided single layer or multi-layer PCB. The PCB 322 includes at least one layer with conductors on one or both sides, or even on inner layers, and including a plurality of conductor through holes 320 for mounting a connector to the PCB 322. The PCB 322 may also include a plurality of additional conductor through holes within the spiral coils and other locations of the PCB. The PCB 322 may be made of a material that is rigid or flexible.

In an exemplary embodiment, the coil array PCB 322 includes twelve (12) separate coils, plus a calibration coil. Four of the coils are single spiral coils 301, 302, 303 and 321. Eight of the coils are spiral coil pairs 304-312, 307-315, 306-314, 305-313, 311-319, 308-316, 310-318, and 309-317. The second spiral coil in each pair is wound in the opposite direction from the first spiral coil to form electromagnetic fields that are parallel to the plane of the PCB 322. The spiral coils are arranged to generate electromagnetic fields and gradients in all three axes (x, y, and z) directions at a “sweet spot” located above at least one side of the PCB 322. The x and y directions are in the plane of the PCB 322. The z direction is perpendicular to the plane of the PCB 322.

A first coil (coil 1) comprises first spiral coil 304 and second spiral coil 312. A second coil (coil 2) comprises first spiral coil 307 and second spiral coil 315. A third coil (coil 3) comprises first spiral coil 306 and second spiral coil 314. A fourth coil (coil 4) comprises first spiral coil 305 and second spiral coil 313. A fifth coil (coil 5) comprises first spiral coil 311 and second spiral coil 319. A sixth coil (coil 6) comprises first spiral coil 308 and second spiral coil 316. A seventh coil (coil 7) comprises first spiral coil 310 and second spiral coil 318. An eighth coil (coil 8) comprises first spiral coil 309 and second spiral coil 317. A ninth coil (coil 9) comprises spiral coil 302. A tenth coil (coil 10) comprises spiral coil 303. An eleventh coil (coil 11) comprises spiral coil 301. A twelfth coil (coil 12) comprises spiral coil 321. Spiral coil 321 (coil 12) is located around the edges or periphery of PCB 322 and thus surrounds all the other spiral coils.

In an exemplary embodiment, the RFID transponder 108, 208 of FIGS. 1 and 2 may be read by a large outer spiral coil 321 on the PCB 322 of the electromagnetic receiver or transmitter coil array 300.

In an exemplary embodiment, the PCB 322 does not include coils with curved traces. Electromagnetic fields may be more precisely calculated with coils having straight-line segments.

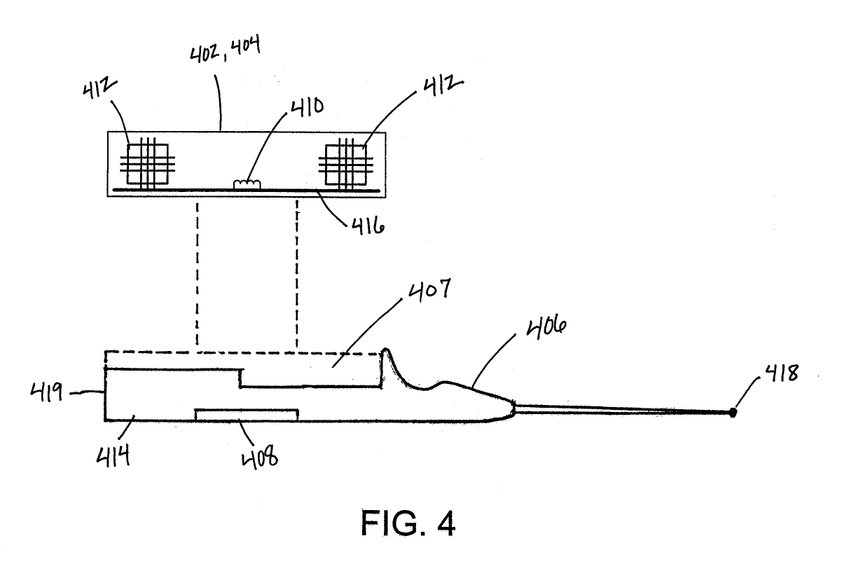

FIG. 4 is a schematic diagram illustrating an exemplary embodiment of an instrument 406 with a RFID transponder 408 attached thereto and an electromagnetic transmitter or receiver assembly 402, 404 configured to be removably coupled to the instrument 406. The instrument 406 includes a distal end 418 and a proximal end 419 with a handle assembly 414 nearest the proximal end 419. The handle assembly 414 includes a cavity 407 for receiving the electromagnetic transmitter or receiver assembly 402, 404 therein. In an exemplary embodiment, the RFID transponder 408 is attached to the handle assembly 414. The handle assembly 414 acts as the mechanical interface for removably attaching the electromagnetic transmitter or receiver assembly 402, 404 within the cavity 407 of the handle assembly 414. In an exemplary embodiment, the electromagnetic transmitter or receiver assembly 402, 404 removably snaps into place within the cavity 407 of the handle assembly 414.

In an exemplary embodiment, the electromagnetic transmitter or receiver assembly 402, 404 includes at least two electromagnetic devices 412 mounted to a PCB 416, and an excitation device 410 mounted to the PCB 416. When the electromagnetic transmitter or receiver assembly 402, 404 is removably mounted within the cavity 407 of the handle assembly 414, the excitation device 410 is located adjacent to the RFID transponder 408. Information transfer takes place when the electromagnetic transmitter or receiver assembly 402, 404 is removably snapped into place. The excitation device 410 provides enough of a signal to energize the RFID transponder 408. The RFID transponder 408 identifies the type of instrument 406 to a remote electromagnetic receiver or transmitter assembly (not shown). Signals from the RFID transponder 408 are detected by the remote electromagnetic receiver or transmitter assembly (not shown) configured to act as a RFID reader, which transfers the signals to a computer for interpretation by system software to identify the type of instrument(s) being tracked.

In an exemplary embodiment, the RFID transponder 408 may be attached to the instrument 406 or the handle assembly 414.

In an exemplary embodiment, the RFID transponder 408 may be built into the handle assembly 414.

In an exemplary embodiment, a docking member (not shown) may be included as a mechanical interface between the instrument and the electromagnetic transmitter and receiver assembly. In other words, the docking member provides for the electromagnetic transmitter and receiver assembly to be removably attached to the instrument or the instrument handle assembly. A mechanical attachment mechanism is built into the docking member. The RFID transponder may be attached to the instrument, the instrument handle assembly, or the docking member.

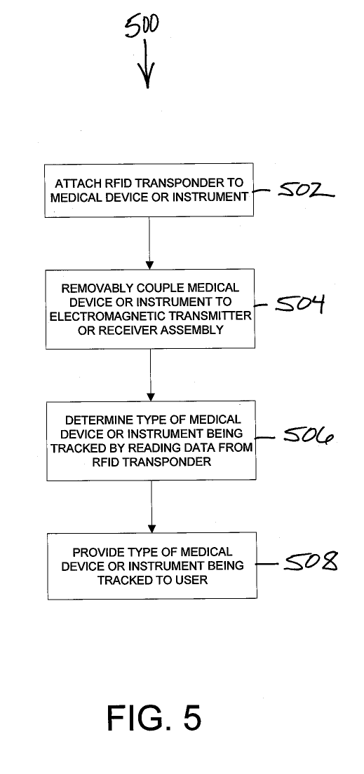

FIG. 5 is a flow diagram illustrating an exemplary embodiment of a method 500 for instrument identification in an electromagnetic tracking system. The method 500 may be performed on an electromagnetic tracking system having at least one transmitter assembly with one or more electromagnetic devices or an electromagnetic device array and at least one receiver assembly with one or more electromagnetic devices or an electromagnetic device array for position and orientation tracking of at least one instrument that may be removably attached to the at least one receiver assembly or the at least one transmitter assembly, according to any suitable method or system. The method 500 may be performed by at least one computer program or algorithm running on a tracking system computer.

The method 500 includes attaching a RFID transponder to a medical device or instrument at step 502. The RFID transponder is programmed with data including a unique identifier for identifying the medical device or instrument it is to be attached to.

The medical device or instrument is removably coupled to an electromagnetic transmitter or receiver assembly at step 504. The electromagnetic tracking system determines the type of medical device or instrument being tracked by an electromagnetic receiver or transmitter assembly reading data from the RFID transponder at step 506. In order to read data including a unique instrument identifier from the RFID transponder, the RFID transponder is activated by a magnetic field emitted by an excitation device and received by the RFID transponder. The magnetic field induces a voltage in the RFID transponder circuitry to activate the RFID transponder. Following activation, the data including the unique instrument identifier is transmitted to at least one electromagnetic receiver or transmitter assembly acting as a RFID reader in the form of an electromagnetic signal. The electromagnetic signal is decoded and restructured by the at least one electromagnetic receiver or transmitter assembly (RFID reader) for transmission to a computer for processing. The type of medical device or instrument being tracked is provided to a user at step 508. This may be accomplished through a visualization of the instrument on a display or through a message of the instrument identification on the display or on a user interface.

Several embodiments are described above with reference to drawings. These drawings illustrate certain details of exemplary embodiments that implement the systems, methods and computer programs of this disclosure. However, the drawings should not be construed as imposing any limitations associated with features shown in the drawings.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to various embodiments, those skilled in the art will appreciate that certain substitutions, alterations and omissions may be made to the embodiments without departing from the spirit of the invention. Accordingly, the foregoing description is meant to be exemplary only, and should not limit the scope of the disclosure as set forth in the following claims.

What is claimed is:

1. A system for instrument identification in an electromagnetic tracking system comprising:
at least one electromagnetic transmitter assembly with one or more electromagnetic transmitter devices;
at least one electromagnetic receiver assembly with one or more electromagnetic receiver devices, the at least one receiver assembly communicating with and receiving signals from the at least one transmitter assembly;
at least one medical device or instrument removably coupled to the at least one electromagnetic transmitter assembly; and
an RFID transponder attached to the at least one medical device or instrument.

2. The system of claim 1, wherein the at least one electromagnetic transmitter assembly includes an excitation device to energize the RFID transponder.

3. The system of claim 2, wherein the excitation device is located adjacent to the RFID transponder when the at least one electromagnetic transmitter assembly is removably coupled to the at least one medical device or instrument.

4. The system of claim 1, wherein the at least one electromagnetic receiver assembly is configured as an RFID reader communicating with the RFID transponder.

5. The system of claim 1, wherein the RFID transponder is programmed with data including a unique identifier for identifying the medical device or instrument it is attached to.

6. The system of claim 5, wherein the at least one electromagnetic receiver assembly is configured to read data including the unique identifier from the RFID transponder for identifying the medical device or instrument removably coupled to the to the at least one electromagnetic transmitter assembly.

7. The system of claim 1, wherein the RFID transponder is a passive RFID transponder.

8. The system of claim 1, wherein the RFID transponder is an active RFID transponder.

9. A system for instrument identification in an electromagnetic tracking system comprising:
at least one electromagnetic transmitter assembly with one or more electromagnetic transmitter device;
at least one electromagnetic receiver assembly with one or more electromagnetic receiver device, the at least one receiver assembly communicating with and receiving signals from the at least one transmitter assembly;
at least one medical device or instrument removably coupled to the at least one electromagnetic receiver assembly; and
an RFID transponder attached to the at least one medical device or instrument.

10. The system of claim 9, wherein the at least one electromagnetic transmitter assembly includes an excitation device to energize the RFID transponder.

11. The system of claim 10, wherein the excitation device is located adjacent to the RFID transponder when the at least one electromagnetic transmitter assembly is removably coupled to the at least one medical device or instrument.

12. The system of claim 9, wherein the at least one electromagnetic receiver assembly is configured as an RFID reader communicating with the RFID transponder.

13. The system of claim 9, wherein the RFID transponder is programmed with data including a unique identifier for identifying the medical device or instrument it is attached to.

14. The system of claim 13, wherein the at least one electromagnetic receiver assembly is configured to read data including the unique identifier from the RFID transponder for identifying the medical device or instrument removably coupled to the to the at least one electromagnetic transmitter assembly.

15. A method for instrument identification in an electromagnetic tracking system comprising:
attaching a RFID transponder to a medical device or instrument;
removably coupling the medical device or instrument to an electromagnetic transmitter assembly;
determining the identity of the medical device or instrument being tracked by reading data from the RFID transponder; and
providing the identity of the medical device or instrument being tracked to a user.

16. The method of claim 15, wherein the RFID transponder is programmed with data including a unique identifier for identifying the medical device or instrument it is attached to.

17. The method of claim 15, wherein the RFID transponder is activated by a magnetic field emitted by an excitation device on the at least one electromagnetic transmitter assembly.

18. The method of claim 16, wherein the at least one electromagnetic receiver assembly is configured to read data including the unique identifier from the RFID transponder for identifying the medical device or instrument removably coupled to the to the at least one electromagnetic transmitter assembly.

19. A method for instrument identification in an electromagnetic tracking system comprising:
attaching a RFID transponder to a medical device or instrument;
removably coupling the medical device or instrument to an electromagnetic receiver assembly;
determining the identity of the medical device or instrument being tracked by reading data from the RFID transponder; and
providing the identity of the medical device or instrument being tracked to a user.

20. The method of claim 19, wherein the RFID transponder is programmed with data including a unique identifier for identifying the medical device or instrument it is attached to.

21. The method of claim 19, wherein the RFID transponder is activated by a magnetic field emitted by an excitation device on the at least one electromagnetic receiver assembly.

22. The method of claim 20, wherein the at least one electromagnetic transmitter assembly is configured to read data including the unique identifier from the RFID transponder for identifying the medical device or instrument removably coupled to the to the at least one electromagnetic receiver assembly.
